(19) United States
(12) Patent Application Publication
(10) Pub. No.: US 2007/0031207 A1
(43) Pub. Date: Feb. 8, 2007

(54) Lockwire header bolts

(76) Inventor: Amir Rosenbaum, Cupertino, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/195,951

(22) Filed: Aug. 4, 2005

(51) Int. Cl. F16B 39/02

(52) U.S. Cl. 411/102

(57) ABSTRACT

A locking device for preventing the loosening of bolts that are subject to vibration is disclosed. The locking device is a simple to install and remove lockwire section that is placed through bolts having a plurality of holes drilled through head of the bolts. The locking device further includes a spiral wrapped retainer wire that the lockwire is placed through, reducing the possibility that the lockwire will back out of the bolt head. Advantages over traditional safety wire include the elimination of twisting the wire to install and clipping the wire to remove. The lockwire device is used with sets of two bolts, and is ideally suited for automotive applications where engine vibration can loosen manifold bolts.

### FIELD OF THE INVENTION

The present invention relates to a lockwire system for header bolts. More specifically the invention is intended for use in assemblies that are susceptible to loosening due to vibration or other forces. The invention includes a bolt with at least one hole drilled through the head of the bolt and a lockwire that is placed through two bolts. A coiled wire is also provided to keep the lockwire in position in the holes in the heads of the bolts.

### BACKGROUND OF THE INVENTION

Various methods have been used in the past to prevent or reduce the possibility that a nut or bolt will loosen or back out due to vibrations. Methods of this type include castle nuts, thin safety wire, cotter pins, hairpins and Nylock nuts or bolts.

One common method of reducing the rotation of a bolt is with the use of safety wire such as shown in FIG. 1. Safety wire is used with drilled bolts, and a thin wire that is placed through the heads of bolt and then twisted using a special tool and connected to either other bolts or to an anchor to prevent the bolt from loosening. While this method locks bolts from loosening, it is installed using special safety wire pliers, and in order to remove the safety wire, the wire is usually cut. The installation is usually arduous, and requires special equipment.

C. M Rice U.S. Pat. No. 2,758,628 discloses a Bolt and Nut Rotation Restraining Means consisting of a special clip member retainer that fits over a bolt. A wire is placed through the special clip member to prevent the bolt from backing out. This patent is most specifically designed for use with the nuts on the wheels of an automobile. While this patent discloses a method of preventing the loosening of bolts, it requires special clip members that are placed around the bolt pattern. Because the safety wire does not go through an anchor location the bolt retaining means can loosen off of all the bolts, and the entire bolt retaining means can fall off as a set.

James R. Quales U.S. Pat. No. 4,298,299 discloses a cotter pin that is placed through the end of a smooth shaft or nut. The cotter pin is easily installed and removed. While the cotter pin can be placed through a bolt and nut to prevent the nut from loosening on the bolt, it requires that a hole be drilled through both the nut and the bolt, and that the holes be aligned in order to place the wire through the nut and bolt.

Anthony U.S. Pat. No. 4,893,975 discloses a locking device for engagement onto bolt heads consisting of a special locking plate that fits over a bolt. A wire is placed through the special locking plate member to prevent the bolt from backing out. This patent is most specifically designed for use with the nuts on an aircraft engine. While this patent discloses a method of preventing the loosening of bolts, it requires special locking plate members that are placed over the bolts. A safety wire is then placed through the head of the bolt to prevent the locking plate from sliding off the bolt head(s). The invention uses multiple safety wires that go through two bolts and also a separate locking plate that adds complexity and expense to the assembly.

What is needed is a simple method to install and remove lockwire for header bolts that can be installed without requiring special tooling. The ideal device would be packaged in a single kit containing multiple sets of drilled bolts, lockwire and retainer coils to prevent the possibility that the bolts will not back-out. The proposed application satisfies these requirements.

### BRIEF SUMMARY OF THE INVENTION

It is an object of the lockwire to provide a bolt retention mechanism that prevents a bolt from loosening. The loosening can be caused by vibration or thermal expansion and contraction.

It is another object to provide bolts with holes that are pre-drilled through the flats of the bolt. The pre-drilled holes can accept a lockwire to prevent the possibility that the bolt will loosen while it is installed in an automotive application.

It is another object of the lockwire components to provide pre-drilled bolts that are heat-treated to allow for higher torque capability of the bolts when they are installed in an automobile or other application.

It is another object of the lockwire to provide a lockwire that is easy to install and remove without requiring the use of special tools.

It is another object the lockwire to provide a lockwire with a helical retaining mechanism that prevents the lockwire from falling out of the bolts that are retained by the lockwire.

It is another object of the lock wire kit to provide bolts that include both a hexagonal head for use with a conventional socket wrench or open-end wrench. An installation tool is provide with a hex or Allen drive socket for ease of installation where the Allen head socket is used to start the bolt, and the external hexagonal head is used to torque the bolt to the desired setting prior to the installation of the lockwire.

It is another object of the lockwire to provide a lockwire that can be formed or deformed for placement through the holes of the bolts, after the bolts are torqued to the desired setting. The lockwire is placed through the helical coil and then placed through the holes in the heads of the bolts and remain in place.

It is another object of the lockwire kit to provide an installation tool that is compatible for use with a standard socket wrench on one end and a multi-position Allen key wrench on the other. The Allen key wrench is used in combination with the socket wrench and the lock wire bolt to start and drive the bolt into a threaded hole.

It is still another object of the lockwire to provide a kit of multiple drilled bolts, multiple lockwire, multiple helical retaining coils and an installation all in one kit to allow a user to install the lockwire without the need to purchase the components separately.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is various prior art methods of using a wrapped lockwire.

FIG. 2 is two views of the preferred embodiment of the drilled bolt.

FIG. 3 is a view of lockwire as installed in the preferred embodiment.

FIG. 4 is a view showing the included installation tool.

FIG. 5 is a view of the packaged lockwire.

### DESCRIPTION

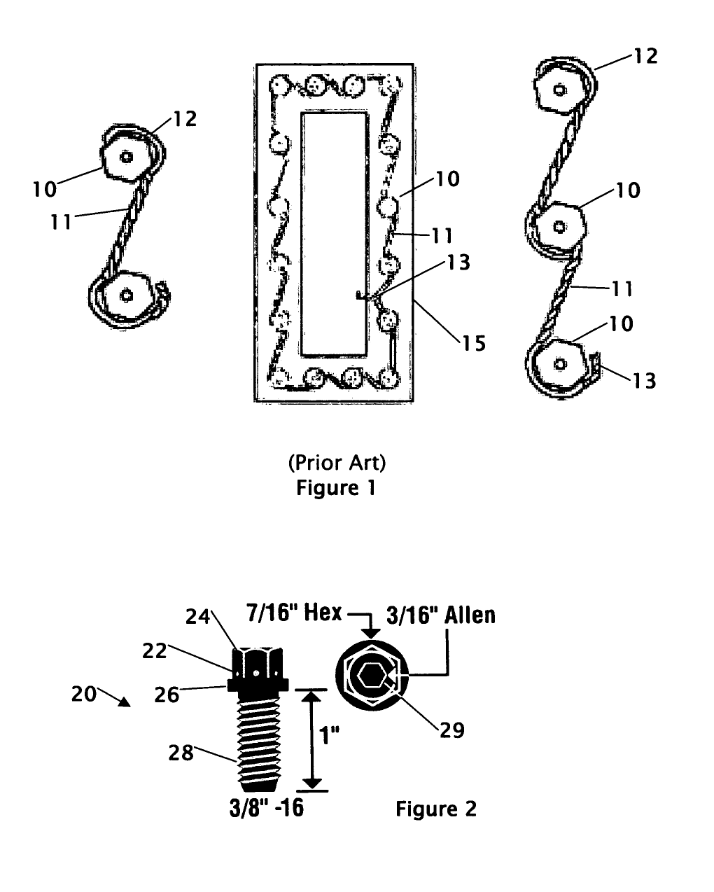

Refer first to FIG. 1 that shows various prior art methods of using a wrapped safety wire. This figure shows three views of a common method of securing nuts 10 with safety wire 12. The view on the left shows two nuts being secured. The view on the right shows three nuts being secured. The middle view shows the safety wire wrapped on multiple bolts as it might be installed on a manifold 15. This type of safety wire installation involves using drilled head bolts, and passing a thin flexible wire through the head of each bolt. After the wire is passed through the head of each bolt, the ends of the wire are brought together and a special safety wire tool is incorporated to twist 11 the wires together. The process of passing the ends of the wire through each bolt and twisting the free ends is continued until all the bolts have been secured and the ends of the wire are twisted together 13.

FIG. 2 shows two views of the preferred embodiment of the drilled bolt. The bolt 20 is constructed in a similar method that a standard hex bolt is manufactured. In the preferred embodiment, the bolt is a high torque rated heat-treated steel bolt. Other materials for the bolt are contemplated and include but are not limited to aluminum, copper, brass, stainless steel, plastics, or combination thereof. A bolt is shown as the preferred embodiment, but the threaded fastener may be a screw or nut that has at least one hole drilled through the head, flat or side of the fastener and a wire can be passed through the hole. In the preferred embodiment the bolt is constructed with a hexagonal shaped head 24. The head has holes drilled 22 or fabricated perpendicular to the flats on the sides of the head. In the preferred embodiment a hole goes through each of the six flat side of the bolt. The drilled hole(s) can be in a range from 0.050 to 0.100. In the preferred embodiment the hole is nominally 0.076 inches in diameter. The bolt is also constructed with a flange 26 or integrated washer to eliminate the need for an additional washer and or to distribute the load from the bolt to larger area. A threaded area 28 exists on the side opposite the head of the bolt. The threaded area is for engagement in the hole where the bolt will be threaded in. In the embodiment shown the entire length of the bolt is shown threaded, but the bolt may include a non-threaded area under the head of the bolt. Referring now to the top of the bolt, an Allen or hex head recess is provided to allow a secondary driving location to thread the bolt into the manifold. This embodiment shows the bolt with a 7/16″ external hex drive side and a 3/16″ hex internal drive side with the bolt having an overall length of ⅞ inch. While these dimensions are shown as one contemplated embodiment, other dimensions and drive configurations are possible provided a through hole can be placed through the head of the threaded fastener.

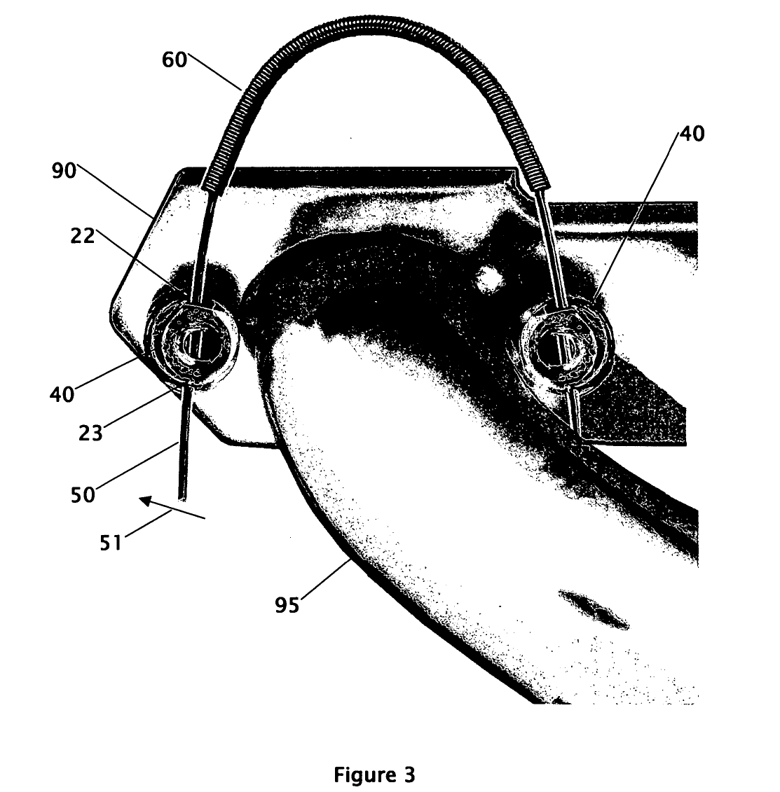

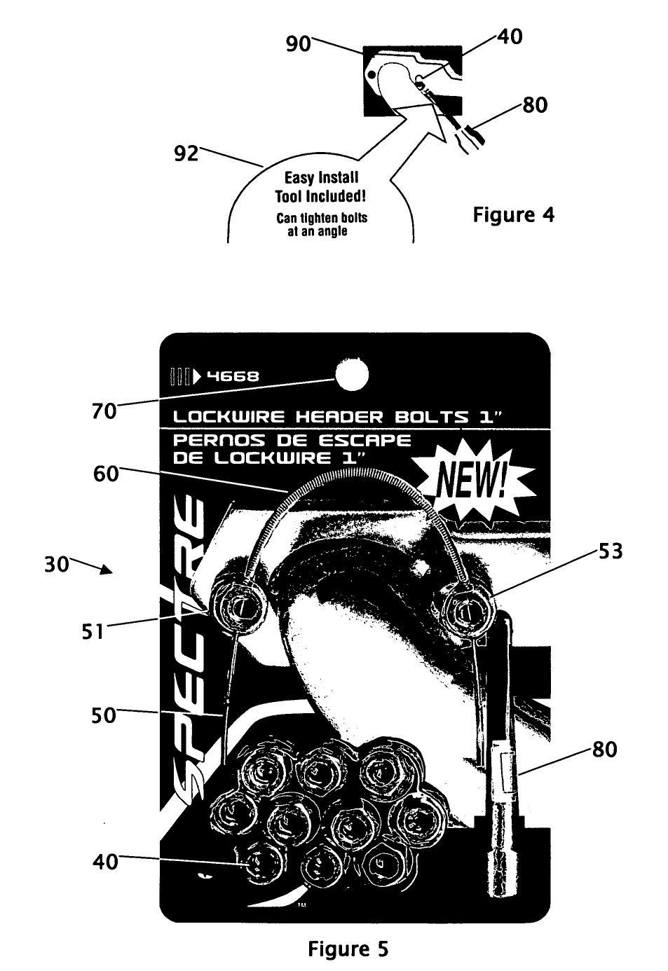

FIG. 3 shows a view of lockwire as installed in the preferred embodiment. This figure shows the bolts 40 installed on an exhaust header 95 as they may be used in an automotive application. For this type of application the header is placed onto the vehicle with any required gasket material between the header and the engine block. Once the header is brought into position the lockwire header bolts can be installed onto the engine. FIG. 4 shows one possible installation method used for this installation. In FIG. 4 the header 90 is shown with a bolt 40. An instructional prompt 92 shows some information regarding the use of the installation tool 80 that can be used in the installation. The tool 80 consists of a driver with a ⅜″ socket fitting on one side and an Allen or hex driver on the other. The hex driver can be placed into the head of the bolt, and the bolt can be seated onto the header-mounting flange 90. The header exhaust tube 95 is shown in this figure as it is connected to the header-mounting flange. The instruction information 92 indicates that the hex driver tool allows driving the bolt at an angle making the installation of the bolts simpler. Referring back to FIG. 3 for further clarification on the lockwire installation. After the bolts have been installed onto the header, the bolts can be torqued to the required specifications.

Once the bolts are torqued, as required, the lockwire 50 with the coiled retainer member 60 is placed into the holes 22 in the heads of each bolt until the lockwire exits the bolt on the other side of the through hole 23. The ends of the wires are slightly bent out 51 to lock them into the bolts. The bent ends and the coiled retainer member 60 provide sufficient friction and hold to the lockwire to reduce the possibility that the lockwire will move in the drilled holes in the bolts. The lockwire is not twisted or locked onto itself, another wire, or onto another component to retain the lockwire in place.

The lockwire is fabricated from a corrosion resistant material that will not melt under the temperatures of engine. The lockwire may be fabricated from material including, but not limited to, aluminum, copper, brass, stainless steel or combination thereof. In the preferred embodiment the lockwire is made from stainless steel. The diameter of the lockwire can range from 0.02 to 0.08 inches in diameter and more preferably 0.040 to 0.060 inches in diameter. In the preferred embodiment the wire is nominally 0.046 inches in diameter or 18-gage wire.

The coiled retainer wire is fabricated from a corrosion resistant material that will not melt under the temperatures of engine. The coiled retainer may be fabricated from material including but not limited to aluminum, copper, brass, stainless steel or combination thereof. In the preferred embodiment the coiled retainer wire is made from stainless steel. The diameter of the coiled retainer wire can range from 0.01 to 0.15 inches in diameter and more preferably 0.015 to 0.050 inches in diameter. In the preferred embodiment the wire is 0.023 inches in diameter or 23-gage wire. The coiled retainer wire has an outside diameter sufficient to wrap around the lockwire to allow movement of the lockwire without allowing the lockwire to fall free through the coiled retaining wire. In the preferred embodiment the outside diameter is nominally 0.135 inches in diameter.

FIG. 5 shows a view of the packaged lockwire. This packaging method 30 shows one contemplated embodiment that the lockwire header bolts can be packaged for sale. The packaging includes at least two drilled bolts 40, and in the packaging shown twelve bolts are included. A lockwire 50 and coiled retainer wire 60 are shown in the packaging placed through a set of drilled header bolts 51 and 53. In this embodiment of packaging a hole 70 is used to hold the packaging on a display rack. The packaging further includes an installation tool 80 that is provided to assist in the installation of the lockwire header bolts.

Thus, specific embodiments and applications for a lockwire utilizing a lockwire with a helical retainer for the lockwire have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A lockwire comprising:
at least two threaded members with at least one through hole through the head of the threaded member;
a lockwire that is placed through the at least one through hole of two threaded members, and
a coiled retainer member that is placed around the lockwire between the two threaded members to prevent the lockwire from dislodging from the threaded members.

2. The lockwire from claim 1 wherein the at least two threaded members are selected from a group consisting of nuts, bolts, and screws.

3. The lockwire from claim 1 wherein the at least one through hole goes through the perpendicular flats of the threaded fastener.

4. The lockwire from claim 1 wherein the at least two threaded members have a head shaped for use with a hex shaped installation tool.

5. The lockwire from claim 1 wherein more than one set of parallel through holes go through the perpendicular flats of the threaded fastener.

6. The lockwire from claim 1 wherein the threaded fastener further includes an integrated washer or flange between the head and the threaded portion.

7. The lockwire from claim 1 wherein the lockwire has a diameter in a range of 0.02 to 0.08 and more preferred in a range of 0.040 to 0.060.

8. The lockwire from claim 1 wherein the coiled retainer member is made from wire having a diameter in a range of 0.01 to 0.15 and more preferred in a range of 0.015 to 0.040 inches in diameter.

9. The safety lockwire from claim 1 that further includes a kit of more than one set of multiple threaded members, lock wires and coiled retainer members.

10. The lockwire from claim 9 that further includes an installation tool.

11. A lockwire comprising:
at least two threaded members with at least one through hole through the head of the threaded member;
a lockwire that is placed through the at least one through hole of two threaded members wherein the retention of the lockwire is not dependant upon a twisting of the lockwire or a pre-defined shape of the lockwire

12. The lockwire from claim 11 wherein the at least two threaded members are selected from a group consisting of nuts, bolts, and screws.

13. The lockwire from claim 11 wherein the at least one through hole goes through the perpendicular flats of the threaded fastener.

14. The lockwire from claim 11 wherein the at least two threaded members have a head shaped for use with a hex shaped installation tool.

15. The lockwire from claim 11 wherein more than one set of through holes go through the perpendicular flats of the threaded fastener.

16. The lockwire from claim 11 wherein the threaded fastener further includes an integrated washer or flange between the head and the threaded portion.

17. The lockwire from claim 11 wherein the lockwire has a diameter in a range of 0.02 to 0.08 and more preferred in a range of 0.040 to 0.060.

18. The lockwire from claim 11 that further includes a coiled retainer member that is placed around the lockwire between the two threaded members to prevent the lockwire from dislodging from the threaded members.

19. The lockwire from claim 11 that further includes a kit of more than one set of multiple threaded members, lock wires and coiled retainer members.

20. The lockwire from claim 19 that further includes an installation tool.
